(19) United States
(12) Patent Application Publication
(10) Pub. No.: US 2024/0357616 A1
(43) Pub. Date: Oct. 24, 2024

(54) NETWORK NODE, USER EQUIPMENT, AND METHODS PERFORMED THEREIN

(71) Applicant: Telefonaktiebolaget LM Ericsson (publ), Stockholm (SE)

(72) Inventor: Bikramjit SINGH, Kirkkonummi (FI)

(21) Appl. No.: 18/291,634

(22) PCT Filed: Jul. 28, 2021
(86) PCT No.: PCT/SE2021/050761

§ 371 Date: Jan. 24, 2024

(51) Int. Cl. H04W 72/232; H04L 1/1867; H04L 5/00

(52) U.S. Cl. CPC H04W 72/232; H04L 1/1896; H04L 5/0005

(57) ABSTRACT

A method performed by a network node for communicating with a User Equipment, UE, and a method performed by the UE for communicating with the network node in the wireless communications network, in which a single downlink control information, DCI, allocates downlink and uplink communications. The method performed by the UE includes receiving a DCI from the network node, and using the information in the DCI to communicate with the network node. The method performed by the network node includes transmitting the DCI to the UE, and using the information in the DCI to communicate with the UE. The DCI comprises information for generating a first number of first communications over a physical downlink shared channel, PDSCH, and a second number of second communications over a physical uplink shared channel, PUSCH, wherein a sum of the first and second numbers is greater than two.

### TECHNICAL FIELD

Embodiments herein relate to a User Equipment (UE), a network node, and methods performed therein. Furthermore, a computer program and a carrier are also provided herein. In some aspects, embodiments relate to a Downlink Control Information (DCI) for handling communications between the UE and the network node in a wireless communications network.

### BACKGROUND

In a typical wireless communication network, wireless devices, also known as wireless communication devices, mobile stations, stations (STA) and/or User Equipment (UE), communicate via a Wide Area Network or a Local Area Network such as a Wi-Fi network or a cellular network comprising a Radio Access Network (RAN) part, and a Core Network (CN) part. The RAN covers a geographical area which is divided into service areas or cell areas, which may also be referred to as a beam or a beam group, with each service area or cell area being served by a network node such as a radio access node e.g., a Wi-Fi access point or a radio base station (RBS), which in some networks may also be denoted, for example, a NodeB, eNodeB (eNB), or gNB as denoted in Fifth Generation (5G) telecommunications. A service area or cell area is a geographical area or indoor area where radio coverage is provided by the network node. The network node communicates over an air interface operating on radio frequencies with the wireless device within range of the network node.

The 3rd Generation Partnership Project (3GPP) is the standardization body for specify the standards for the cellular system evolution, e.g., including 3G, 4G, 5G and the future evolutions. Specifications for the Evolved Packet System (EPS), also called a Fourth Generation (4G) network, have been completed within the 3GPP. As a continued network evolution, the new releases of 3GPP specify a 5G network also referred to as 5G New Radio (NR).

Frequency bands for 5G NR are being separated into two different frequency ranges, Frequency Range 1 (FR1) and Frequency Range 2 (FR2). FR1 comprises sub-6 GHz frequency bands. Some of these bands are bands traditionally used by legacy standards but they have been extended to cover potential new spectrum offerings from 410 MHz to 7125 MHz. FR2 comprises frequency bands from 24.25 GHz to 52.6 GHz. Bands in this millimeter wave range have shorter range but higher available bandwidth than bands in the FR1.

Multi-antenna techniques may significantly increase the data rates and reliability of a wireless communication system. For a wireless connection between a single user, such as a UE, and a base station, the performance is in particular improved if both the transmitter and the receiver are equipped with multiple antennas, which results in a Multiple-Input Multiple-Output (MIMO) communication channel. This may be referred to as Single-User (SU)-MIMO. In the scenario where MIMO techniques are used for the wireless connection between multiple users and the base station, MIMO enables the users to communicate with the base station simultaneously using the same time-frequency resources by spatially separating the users, which increases further the cell capacity. This may be referred to as Multi-User (MU)-MIMO. Note that MU-MIMO may benefit when each UE only has one antenna. Such systems and/or related techniques are commonly referred to as MIMO.

Downlink control information (DCI) provides a UE with information on resource scheduling, power control commands, and other type of control information, wherein the DCI may be transmitted on Physical Downlink Control Channel (PDCCH). The DCI may have various formats that make use of different types of resource allocation.

### SUMMARY

An object of embodiments herein is to improve the way in which DCI allocates resources for bidirectional communications between a UE and a network node in a wireless communications network.

According to an aspect of embodiments herein, the object is achieved by a method performed by a UE for communicating with a network node in a wireless communications network. The UE receives a DCI, from the network node, wherein the DCI comprises information for generating a first number of first communications over a Physical Downlink Shared Channel (PDSCH) and a second number of second communications over a Physical Uplink Shared Channel (PUSCH), wherein a sum of the first and second numbers is greater than two. The UE uses the information in the DCI to communicate with the network node in the wireless communications network.

According to another aspect of embodiments herein, the object is achieved by a method performed by a network node for communicating with a UE in a wireless communications network. The network node transmits a DCI to the UE, the DCI comprising information for generating a first number of first communications over a PDSCH, and a second number of second communications over a PUSCH, wherein a sum of the first and second numbers is greater than two. The network node uses the information in the DCI to communicate with the UE in the wireless communications network.

According to an aspect of embodiments herein, the object is achieved by a UE for communicating with a network mode in a wireless communications network. The UE is configured to receive a downlink control information, DCI, from the network node, the DCI comprising information for generating a first number of first communications over a PDSCH and a second number of second communications over a PUSCH, wherein a sum of the first and second numbers is greater than two. The UE is further configured to use the information in the DCI to communicate with the network node in the wireless communications network.

According to another aspect of embodiments herein, the object is achieved by a network node for communicating with a UE in a wireless communications network. The network node is configured to: transmit a DCI to the UE, the DCI comprising information for generating a first number of first communications over a PDSCH, and a second number of second communications over a PUSCH, wherein a sum of the first and second numbers is greater than two. The network node is further configured to use the information in the DCI to communicate with the UE in the wireless communications network.

In embodiments herein, a single DCI includes information on generating a first number of first communications over the PDSCH and a second number of second communications over the PUSCH, where the sum of the first and second numbers is greater than two. The first and second numbers are each greater than one, and the first and second numbers may differ from one another. Thus, the single DCI advantageously carries information on multiple communications over the PDSCH and PUSCH, thereby decreasing latency and increasing reliability of bidirectional communications in a wireless communications network. This results in an improved way of handling communications of the UE in the wireless communications network, whereby overall performance of the wireless communications network may be improved. Furthermore, the improved latency and reliability expand a range of applications that may make use of the single DCI in accordance with embodiments of the present disclosure, including in developing areas such as, e.g., industrial automation, manufacturing, and autonomous vehicles.

### BRIEF DESCRIPTION OF THE DRAWINGS

Examples of embodiments herein are described in more detail with reference to attached drawings in which:

FIG. 1 is a schematic block diagram illustrating embodiments of a wireless communications network.

FIGS. 2A-2B are schematic block diagrams illustrating communications between a user equipment and a network mode in the wireless communications network.

FIG. 3 is a flowchart depicting an embodiment of a method in a user equipment according to embodiments herein.

FIG. 4. is a flowchart depicting an embodiment of a method in a network node according to embodiments herein.

FIGS. 5A-5B are schematic block diagrams illustrating a user equipment according to embodiments herein.

FIGS. 6A-6B are schematic block diagrams illustrating a network node according to embodiments herein.

FIG. 7 is a schematic illustration of a telecommunication network connected via an intermediate network to a host computer.

FIG. 8 is a generalized block diagram of a host computer communicating via a base station with a user equipment over a partially wireless connection.

FIGS. 9, 10, 11, and 12 are flowcharts illustrating methods implemented in a communication system including a host computer, a base station and a user equipment.

### DETAILED DESCRIPTION

Example embodiments herein relate to methods, UEs, and network nodes for handling communications in a wireless communications network. Embodiments further relate to a downlink control information (DCI) for allocating resources for bidirectional communications between a UE and a network node. In embodiments herein, a single DCI may be used to allocate a certain number of PDSCH communications and a certain number of PUSCH communications. A number of the PUSCH communications may be different from the number of the PDSCH communications. Each communication over PUSCH or PDSCH may have repetitions, e.g. retransmitted a number of times.

The DCI in accordance with embodiments of the present disclosure may be used in scenarios where for every downlink data received from a network node, a UE generates uplink data. Similarly, the network node may generate downlink data for every uplink data received from the UE. Such communications occur, e.g., in environments where the UE and the network node communicate through interactive sessions or in an industrial facility where multiple sensors operate in association with one or both of the UE and network node.

The DCI includes information that defines how resources in a network are allocated for downlink communications from a network node, such as e.g. a base station, to a UE, and for uplink communications from the UE to the network node. The DCI includes information on modulation and coding scheme used for data communication, Transmit Power Control (TPC) commands, information for supporting a Hybrid Automatic Repeat Request (HARQ) operation, and other information which may vary depending on a format of the DCI.

The DCI is transmitted on the Physical Downlink Control Channel (PDCCH) that carries a variety of transport channels. It can be adapted to current conditions on a link between communicating devices, e.g., a UE and a network node. In some cases, the DCI may be transmitted via Physical Downlink Shared Channel (PDSCH). The DCI carries information regarding resource allocation for downlink communications over PDSCH and resource allocation for uplink communications over PUSCH. The PDSCH carries user data, UE-specific higher layer control message, system information blocks (SIBs), and paging information. The PUSCH carries user data, and may also carry uplink control information. In some implementations, the uplink control information is carried by Physical Uplink Control Channel (PUCCH). In a wireless communication network, a UE may look for a PDCCH directed to it, and the UE needs to decode the PDCCH to obtain a required DCI information for further processing. In some embodiments, if the UE decodes the DCI successfully, the UE attempts to decode a PDSCH communication to extract user data sent by a network node. In some embodiments, once the UE decodes the DCI successfully, the DCI may be used to schedule communications over the PDSCH and PUSCH, in a suitable order.

In some embodiments, for every incidence of an attempt to decode the PDSCH communication, corresponding one or more PUSCH communications or one or more of certain acknowledgement message may be generated. The single DCI carries all the information on the PDSCH communications and corresponding PUSCH communications. This improves the way of handling bidirectional communications between a UE and a network node in a wireless communication network, whereby latency is decreased, reliability increased, and thereby overall performance of the wireless communications network may be improved.

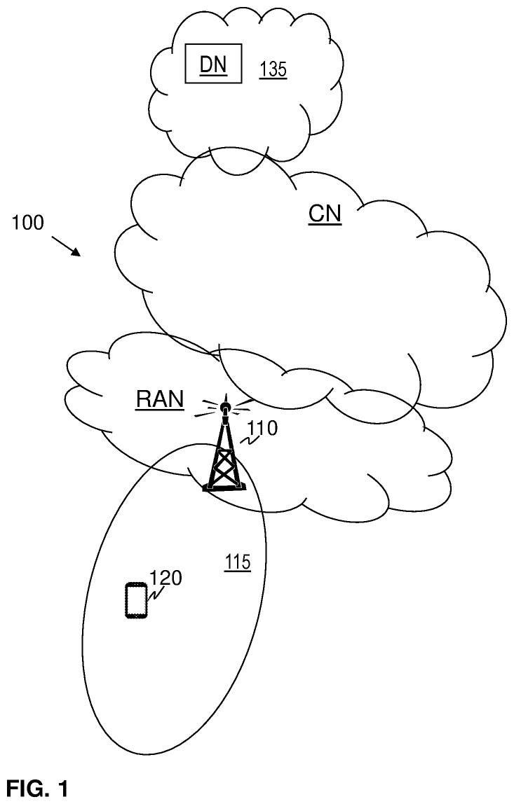

FIG. 1 is a schematic overview depicting a wireless communications network 100 wherein embodiments herein may be implemented. The wireless communications network 100 comprises one or more RANs and one or more CNs. The wireless communications network 100 may use a number of different technologies, such as Wi-Fi, Long Term Evolution (LTE), LTE-Advanced, 5G, NR, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations. Embodiments herein relate to recent technology trends that are of particular interest in a 5G context, however, embodiments are also applicable in further development of the existing wireless communication systems such as e.g. WCDMA and LTE.

A number of network nodes operate in the wireless communications network 100 such as e.g. a network node 110. The network node 110 provides radio coverage in a cell which may also be referred to as a beam or a beam group of beams, such as a cell 115 provided by the network node 110.

The network node 110, may be any of a NG-RAN node, a transmission and reception point e.g. a base station, a radio access network node such as a Wireless Local Area Network (WLAN) access point or an Access Point Station (AP STA), an access controller, a base station, e.g. a radio base station such as a NodeB, an evolved Node B (eNB, eNode B), a gNB, a base transceiver station, a radio remote unit, an Access Point Base Station, a base station router, a transmission arrangement of a radio base station, a stand-alone access point or any other network unit capable of communicating with a UE 120 within the service area served by the network node 110 depending e.g. on the first radio access technology and terminology used.

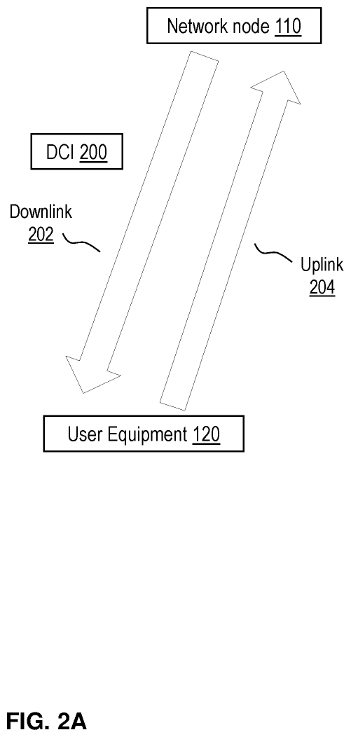

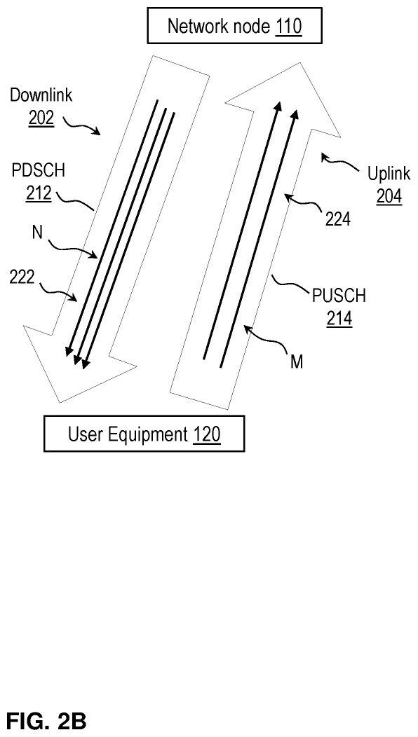

The network node 110 may communicate with the UE 120 in Downlink (DL) transmissions to the UE 120 and Uplink (UL) transmissions from the UE 120. For example, FIG. 2A illustrates DL transmissions 202 transmitted from the network node 110 to the UE 120 and UL transmissions 204 transmitted from the UE 120 to the network node 110 in the wireless communications network 100. In embodiments herein, a DCI 200 is transmitted from the network node 110 to the UE 120, as shown schematically in FIG. 2A.

A number of UEs operate in the wireless communications network 100, such as, e.g., a UE 120. The UE 120 may also be referred to as a device, an IoT device, a mobile station, a non-access point (non-AP) STA, a STA, a user equipment and/or a wireless terminal, communicate via one or more Access Networks (AN), e.g. RAN, to one or more core networks (CN). It should be understood by the skilled in the art that a “wireless device” is a non-limiting term and it means any terminal, wireless communication terminal, user equipment, Machine Type Communication (MTC) device, Device to Device (D2D) terminal, a Vehicle to Everything (V2X) terminal or node e.g. smart phone, laptop, mobile phone, sensor, relay, mobile tablets or even a small base station communicating within a cell.

In various embodiments, the wireless communication network 100, which may be a private network, comprises a system or facility comprising one or more UEs such as autonomous or semi-autonomous robotic devices or robots. The UEs may include or may be associated with various sensors and measurements acquired by the sensors may be provided to the network node 110 which may be, e.g., a base station. As an example, the wireless communication network 100 may be an industrial facility such as, e.g., a manufacturing facility, a warehouse, or another facility employing automation. The sensor measurements may be used to monitor and control devices in the facility and overall operation of the facility. In such embodiments, the UE 120 may be or may be associated with a fully or partially automated robot, a drone, a vehicle, or any other suitable device that forms part of or is associated with the wireless communication network 100 and may communicate with other devices in the wireless communication network 100.

Methods herein may e.g. be performed by the network node 110 and the UE 120. As an alternative, a Distributed Node (DN) and functionality, e.g. comprised in a cloud 135 as shown in FIG. 1, may be used for performing or partly performing the methods herein.

A number of embodiments will now be described, some of which may be seen as alternatives, while some may be used in combination.

The method for handling communications in the wireless communications network 100 using the DCI 200 is performed in the network node 110 and in the UE 120. In some embodiments, the UE 120 receives the DCI, such as the DCI 200 of FIG. 2A, from the network node 110 and uses the DCI to communicate with the network node. Upon receiving the DCI, the UE 120 decodes the DCI and uses information in the DCI to receive a first number of first communications over the PDSCH and to transmit a second number of second communications over the PUSCH. In some embodiments, the first number is different from the second number.

In some embodiments, the wireless communication network 100 comprises more than one UE, and the network node communicates with some or all of these UEs using the method in accordance with the present disclosure. In some embodiments, additionally or alternatively, the wireless communication network 100 comprises more than one UE and more than one network nodes that communicate with some or all of the UEs using the method in accordance with the present disclosure.

FIG. 2B illustrates in more detail downlink communications 202 and uplink communications 204 between the UE 120 and the network node 110 shown in FIG. 2A. As shown in FIG. 2B, the downlink communications 202 from the network node 110 such as, e.g., a base station, to the UE 120 may comprise a first number of first communications 222 over a PDSCH 212. The uplink communications 204 from the UE 120 to the network node 110 may comprise the second number of second communications 224 over a PUSCH 214. In some embodiments, the information about the first number of the first communications 222 and the second number of the second communications 224 is included in a DCI such as DCI 200 shown in FIG. 2A. As illustrated schematically in FIG. 2B, in some embodiments, the first number, e.g., N, of the first communications 222 may be different from the second number, e.g., M, of the second communications 224. Thus, in this example, N=3 and M=2, as shown by arrows representing the first communications 222 transmitted over the PDSCH 212 and the second communications 224 transmitted over PUSCH 214. It should be appreciated that FIG. 2B illustrates communications as defined in the DCI and the first communications 222 and the second communications 224 may be sent at different times. For example, in use, at a certain time point, only one of the first communications 222 may be transmitted over the PDSCH 212. Also, depending on conditions on the network 100 and various circumstances, not all of the communications defined by the DCI may be transmitted as the UE 120 and the network node 110 operate and exchange communications. It should also be appreciated that, in some embodiments, the first number of the first communications 222 may be equal to the second number of the second communications 224, i.e., N may be equal to M.

An uplink and downlink resource allocation in the DCI may comprise allocation in the frequency domain, the time domain, or in a combination of the frequency and time domains. In some embodiments, the resources may be allocated using Orthogonal Frequency Division Multiplexing (OFDM). For example, NR may use Cyclic Prefix OFDM (CP-OFDM) in downlink communications (i.e., from the network node to the UE) and both CP-OFDM and Discrete Fourier transform (DFT)-spread OFDM (DFT-S-OFDM) in the uplink communications (i.e., from the UE to the network node). In the time domain, downlink and uplink physical resources may be organized into equally-sized subframes of 1 millisecond (ms) each. A subframe may be further divided into multiple slots of equal duration, and each slot includes a certain number of symbols. A symbol may be defined as a smallest resource unit that can be scheduled or utilized for any data or control information transmission. A slot is combination of multiple symbols, and a mini-slot is a combination of symbols that is smaller than a slot. A slot length may depend on subcarrier spacing. For example, for subcarrier spacing of 15 kHz, each slot may include 14 OFDM symbols.

Furthermore, in some embodiments, one or more of the first and second communications may comprise repetitions. The repetitions may enhance reliability of a transmission. The repetitions may be scheduled in the time domain, the frequency domain, or in a combination of the time and frequency domains. For example, in the time domain, the repetitions may be slot-based, such that every repetition occurs in a new slot. In some embodiments, in the time domain, the repetitions may be non-slot based manner, e.g. two or more repetitions may occur within a slot.

For example, in some embodiments, referring to FIG. 2B, a first communication from the first number of the first communications 222 comprises at least two repetitions. Additionally or alternatively, in some embodiments, a second communication from the second number of the second communications 224 comprises at least two repetitions. The number of the repetitions of the first communication may be different from the number of the repetitions of the second communication. Also, among the first communications, communications may have different number of repetitions, and communications from the second communications may have different number of repetitions.

It should be appreciated that other physical uplink and downlink channels may be established between the UE 120 and the network code 110 in the wireless communication network 100, which channels are not discussed in detail herein. For example, the uplink channels may comprise Uplink Control Channel (PUCCH) for transmitting control Information, e.g., ACK/NACK communications for PDSCH Hybrid Automatic Repeat Request (HARQ) and Channel Quality Indicator (CQI); and Random Access Channel (PRACH) used for random access, e.g. by a UE that is not a registered to a base station such as e.g. the network node 110. Similarly, the downlink channels may comprise Physical Broadcast Channel (PBCH) for carrying information on the cell such as Master Information Block (MIB) and radio resource configuration for UEs such as System Information Block (SIB), Downlink Control Channel (PDCCH) for resource allocation for downlink and uplink transmissions, and Hybrid-ARQ Indicator Channel (PHICH) for transmitting ACK/NACK communications for PUSCH HARQ.

In some embodiments, ACK/NACK communications for PDSCH HARQ are transmitted over the PDSCH. In some embodiments, ACK/NACK communications for PUSCH HARQ are transmitted over the PUSCH. In some embodiments, a retransmission request is sent by the network node 110 to the UE 120 if an uplink communication, referred to herein as a second communication, is not delivered from the UE 120 to the network node 110. Furthermore, more than one type of NACK communications may be transmitted by the UE 120 in accordance with some embodiments of the present disclosure, as discussed in more detail below.

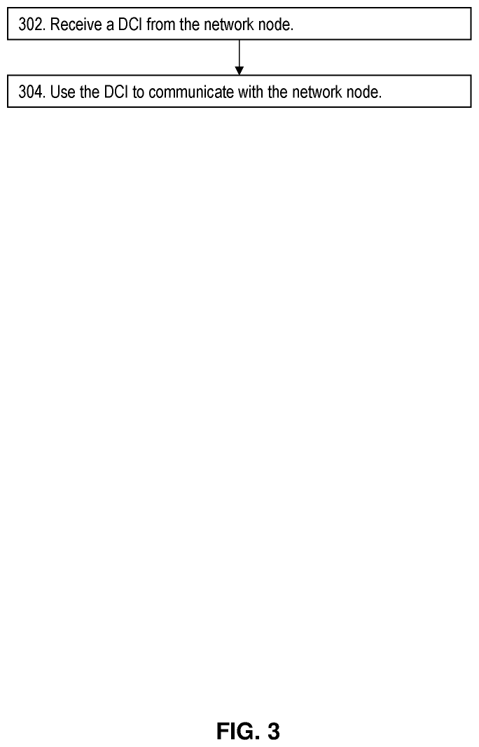

FIG. 3 shows example embodiments of a method performed by the UE 120 for communicating with the network node 110 in the wireless communications network 100.

The method comprises the following actions, which actions may be taken in any suitable order.

### Action 302

The UE 120 obtains receives the DCI from the network node 110. The DCI comprises information for generating the first number of first communications over the PDSCH such as, e.g. PDSCH 212, and the second number of second communications over the PUSCH such as, e.g. PUSCH 214. The sum of the first and second numbers is greater than two. For example, if there is one first communication over the PDSCH, then there are more than one second communications over the PUSCH. Similarly, if there is one second communication over the PUSCH, then there are more than one first communications over the PDSCH. Scheduling of such multiple communications over the PUSCH and PDSCH allows repetitions in bidirectional scheduling, which may improve reliability of uplink and downlink communications. This may be advantageous for applications in which one or more downlink communications are generated in response to one or more uplink communications, or vice versa-one or more uplink communications are generated in response to one or more downlink communications. Examples of such applications include those comprising interactive sessions. For example, in Extended Reality (XR), or gaming applications, there may be a downlink stream over the PDSCH and an uplink video stream of pose control data over the PUSCH. As another example, in industrial applications, a downlink information triggers uplink communication, or vice-versa. Also, in industrial applications, various sensors may be working in unison.

In some embodiments, the first number is different from the second number.

In some embodiments, any one or more out of:
a first communication from the first number of the first communications comprises at least two repetitions,
a second communication from the second number of the second communications comprises at least two repetitions, and
a communication from any one out of the first number of the first communications and the second number of the second communications comprises a first number of repetitions and another communication from any one out of the first number of the first communications and the second number of the second communications comprises a second number of repetitions.

In some embodiments, the information in the DCI specifies that a gap is included between any one out of:
different communications from the first number of the first communications,
different communications from the second number of the second communications,
at least one communication from the first number of the first communications and at least one communication from the second number of the second communications,
different repetitions from the first number of repetitions, and
different repetitions from the second number of repetitions.

In some embodiments, the information in the DCI specifies that any one out of the first number of the first communications, the first number of repetitions of the first number of the first communications, the second number of the second communications, and the second number of repetitions of the second number of the second communications overlaps. The first and second communications, and their repetitions, may overlap in any one or more out of:
a time domain but not in a frequency domain,
the frequency domain but not in the time domain,
partly in the time domain and partly in the frequency domain, and
the time domain and the frequency domain but not in a spatial domain.

In some embodiments, the information in the DCI specifies first parameters for allocating the first number of the first communications and second parameters for allocating the second number of the second communications, wherein the second parameters are different from the first parameters.

In some embodiments, the information in the DCI specifies that a communication from any one out of the first number of the first communications and the second number of the second communications is allocated using any one or more out of:
a same Hybrid Automatic Repeat Request, HARQ, identifier, ID,
a same Modulation and Coding Scheme, MCS, and
a same Physical Layer, PHY, priority.

In some embodiments, the information in the DCI specifies any one or more out of:
the first number of the first communications and the second number of the second communications belong to the same service,
the first number of the first communications and the second number of the second communications belong to different services,
the first number of the first communications comprises N Hybrid Automatic Repeat Request, HARQ, processes and the second number of the second communications comprises M HARQ processes, and one HARQ identifier, ID, is used for the N+M HARQ processes,
a HARQ Acknowledgment, HARQ-ACK of a communication from the first number of the first communications is to be sent in a corresponding communication from the second number of the second communications, and
a HARQ-ACK of a communication from the second number of the second communications is to be sent in a corresponding communication from the first number of the first communications.

In embodiments, the DCI includes information for allocating resources over the PDSCH and PUSCH in a NR or licensed spectrum, unlicensed or NR-U spectrum, Time Division Duplex (TDD), Frequency Division Duplex (FDD), or a combination of thereof.

### Action 304

The UE 120 uses the information in the DCI to communicate with the network node 110 in the wireless communications network 100.

In embodiments herein, the use of the DCI involves detecting and decoding the DCI. In some embodiments, when the attempt to decode the DCI is a successful decoding of the DCI, the UE 120 attempts to decode a downlink communication over the PDSCH. If the decoding of the downlink communication over the PDSCH is successful, the UE generates a corresponding uplink communication over the PUSCH. Furthermore, in some embodiments, when the attempt to decode the DCI is a successful decoding of the DCI, the UE 120 attempts to decode an uplink communication over the PUSCH. And if the decoding of the uplink communication over the PUSCH is successful, the UE generates a corresponding downlink communication over the PDSCH.

In embodiments herein, the DCI may include information on a first number of first, downlink communications and a second number of second, uplink communications. The values of first and second numbers may depend on a certain application which may use the DCI in accordance with embodiments of the present disclosure. For example, if a UE may transmit a large amount of uplink data, it may receive a large amount of downlink data. To transmit a large amount of data, the data may be broken into multiple transport blocks (TBs). A transport block has a dynamic size.

Thus, for multiple communications over the PDSCH, the UE may transmit multiple communications over the PUSCH.

The communication over the PUSCH may comprise data. Information about decoding the downlink communication over the PDSCH, and about encoding data and generating the uplink communication over the PUSCH is included in the same DCI. Multiple downlink and uplink communications may be exchanged with the network node 110, as the DCI in accordance with embodiments of the present disclosure may include information on multiple first communications over the PDSCH and multiple second communications over the PUSCH.

In some embodiments, if a result of the decoding of the downlink communication over the PDSCH is a decoding failure, the UE may transmit a NACK communication, e.g., a first type of the NACK communication, over the PUSCH.

In some embodiments, if a result of the decoding of the downlink communication over the PDSCH is a failure to detect that communication, the UE may transmit a NACK communication, e.g., a second type of the NACK communication, over the PUSCH.

In some embodiments, if an attempt to detect the DCI is a failure to detect the DCI, the UE does not attempt to decode the communication over the PDSCH, and no communication over the PUSCH is transmitted. In some embodiments, if an attempt to decode the DCI is a failure to decode the DCI, the UE may not attempt to decode the communication over the PDSCH and no communication over the PUSCH is transmitted.

In embodiments herein, the DCI includes information required to generate, responsive to a communication over the PDSCH, a communication over the PUSCH. In some embodiments, multiple communications over the PUSCH may be transmitted in response to the communication over the PDSCH. In some embodiments, multiple communications over the PUSCH may be transmitted in response to multiple communications over the PDSCH.

Use of the DCI in accordance with embodiments of the present disclosure may allow improvement in reliability of Ultra-Reliable Low-Latency Communications (URLLCs) and Enhanced Mobile bad d (eMBB) communications. For example, an URLLC may be delivered in one direction, (e.g. with repetitions), and an eMBB communication may be delivered in the other direction, e.g., without repetitions. For example, the URLLC may be delivered in a downlink and an eMBB communication may be delivered in an uplink. As another example, the URLLC may be delivered in an uplink and an eMBB communication may be delivered in a downlink. As a further example, the URLLC and the eMBB communication may be both delivered in the downlink or both in the uplink, and both may have repetitions.

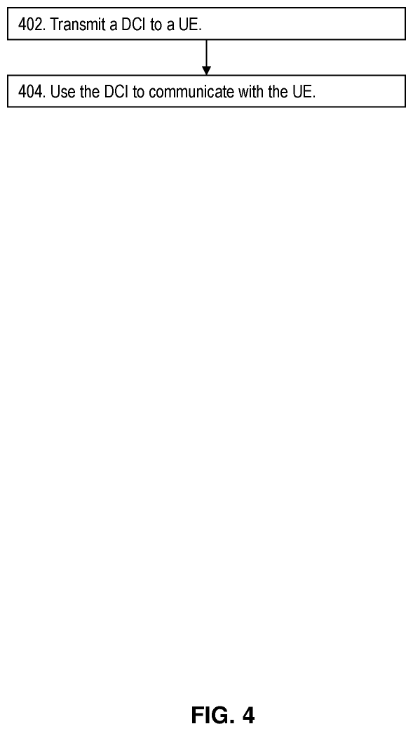

FIG. 4 shows example embodiments of a method performed by the network node 110 for communicating with the UE 120 in the wireless communications network 100. In some embodiments, the network node 110 may be a base station such as, e.g. a gNodeB.

### Action 402

The network node 110 transmits the DCI to the UE 120. The DCI comprises information for generating the first number of first communications over a PDSCH such as, e.g. PDSCH 212, and the second number of second communications over a PUSCH such as, e.g. PUSCH 214. The sum of the first and second numbers is greater than two.

In some embodiments, the first number is different from the second number.

In some embodiments, the first and second numbers are each greater than one.

In some embodiments, any one or more out of:
a first communication from the first number of the first communications comprises at least two repetitions,
a second communication from the second number of the second communications comprises at least two repetitions, and
a communication from any one out of the first number of the first communications and the second number of the second communications comprises a first number of repetitions and another communication from any one out of the first number of the first communications and the second number of the second communications comprises a second number of repetitions.

In some embodiments, the information in the DCI specifies that a gap is included between any one out of:
different communications from the first number of the first communications,
different communications from the second number of the second communications,
at least one communication from the first number of the first communications and at least one communication from the second number of the second communications,
different repetitions from the first number of repetitions, and
different repetitions from the second number of repetitions.

In some embodiments, the information in the DCI specifies that any one out of the first number of the first communications, the first number of repetitions of the first number of the first communications, the second number of the second communications, and the second number of repetitions of the second number of the second communications overlaps. The first and second communications, and their repetitions, may overlap in any one or more out of:
a time domain but not in a frequency domain,
the frequency domain but not in the time domain,
partly in the time domain and partly in the frequency domain, and
the time domain and the frequency domain but not in a spatial domain.

In some embodiments, the information in the DCI specifies first parameters for allocating the first number of the first communications and second parameters for allocating the second number of the second communications, wherein the second parameters are different from the first parameters.

In some embodiments, the information in the DCI specifies that a communication from any one out of the first number of the first communications and the second number of the second communications is allocated using any one or more out of:
a same Hybrid Automatic Repeat Request, HARQ, identifier, ID,
a same Modulation and Coding Scheme, MCS, and
a same Physical Layer, PHY, priority.

In some embodiments, the information in the DCI specifies any one or more out of:
the first number of the first communications and the second number of the second communications belong to the same service,
the first number of the first communications and the second number of the second communications belong to different services,
the first number of the first communications comprises N Hybrid Automatic Repeat Request, HARQ, processes and the second number of the second communications comprises M HARQ processes, and one HARQ identifier, ID, is used for the N+M HARQ processes,
   a HARQ Acknowledgment, HARQ-ACK of a communication from the first number of the first communications is to be sent in a corresponding communication from the second number of the second communications, and
   a HARQ-ACK of a communication from the second number of the second communications is to be sent in a corresponding communication from the first number of the first communications.

In embodiments, the DCI includes information for allocating resources in a NR or licensed spectrum, unlicensed or NR-U spectrum, Time Division Duplex (TDD), Frequency Division Duplex (FDD), or a combination of thereof.

### Action 404

The network node 110 uses the information in the DCI to communicate with the UE 120 in the wireless communications network 100. The communications may occur in a manner similar to that described above in connection with the UE 120. Furthermore, examples of the use of the DCI for handling communications between the network node 110 and the UE 120 are described below.

The embodiments described in connection with FIGS. 2A, 2B, 3 and 4 will now be further explained and exemplified below. The embodiments below may be combined with any suitable embodiment(s) above.

As discussed above, in some embodiments, a first communication over the PDSCH may be received by the UE before the UE transmits a second communication over the PUSCH. Furthermore, in some embodiments, the UE 120 may transmit a second communication over the PUSCH before the UE 120 receives a first communication over the PDSCH.

In some embodiments, the UE 120 receives a first communication over the PDSCH, processes the first communication, and, in response, transmits a second communication over the PUSCH. It should be appreciated, however, that the second communication over the PUSCH may be transmitted in some cases as scheduled in the DCI, and not necessarily in response to the first communication over the PDSCH.

In some embodiments, the second communication may be, e.g., a HARQ ACK or NACK communication. In some embodiments, the second communication is different from a HARQ ACK or NACK communication.

In some embodiments, upon receiving the DCI and a first communication over the PDSCH, the UE 120 attempts to decode the DCI and, if the DCI is decoded successfully, attempts to decode the first communication. The UE 120 may use the information in the DCI to transmit a second communication over the PUSCH, based on a result of attempting to decode the DCI and a result of attempting to decode the first communication over the PDSCH.

In some embodiments, when the result of attempting to decode the DCI is successful decoding of the DCI and when the result of attempting to decode the first communication over the PDSCH communication is successful decoding of the first communication, the UE 120 transmits a second communication over the PUSCH. For example, the UE 120 transmits the second communication comprising data. In an embodiment, the data transmitted in the second communication may be sensor measurements acquired by one or more sensors included in or otherwise associated with the UE 120.

In some embodiments, when the result of attempting to decode the DCI is successful decoding of the DCI, the UE 120 may detect the receipt of the first communication over the PDSCH but may nevertheless fail to decode that first communication. In such embodiments, when the result of attempting to decode the first communication over the PDSCH communication is a failure to decode the first communication, the UE 120 transmits a second communication over the PUSCH, which second communication comprises a first type of a NACK communication. The first type of the NACK communication includes indicating the failure to decode the first communication over the PDSCH.

In some embodiments, when the result of attempting to decode the DCI is successful decoding of the DCI, the UE 120 may fail to detect the receipt of the first communication over the PDSCH. In such embodiments, the UE 120 transmits a second communication over the PUSCH, which second communication comprises a second type of a NACK communication indicating the failure to detect the first communication over the PDSCH.

The first type of the NACK communication or the second type of the NACK communication may be transmitted based on a level of transport block (TB) energy detected by the UE 120. Data on a transport channel is organized into TBs, and a TB is transmitted with some power and it is received with some power after it passes through a channel. The power or energy with which the TB is received may be detected and used to determine a type of the NACK communication to transmit. Thus, in some embodiments, the first type or the second type of the NACK communication is transmitted based on whether or not the UE 120 detects that TB energy is below a threshold. The first type of the NACK communication may be transmitted when the TB energy is below the threshold, and that the second type of the NACK communication may be transmitted when the TB energy is above the threshold. The failure to detect the PDSCH communication by the UE 120 may be associated with detecting by the UE 120 that the TB energy is above the threshold.

In some embodiments, the first type of the NACK communication and the second type of the NACK communication are each not based on a hybrid automatic repeat request-acknowledgement (HARQ-ACK) codebook.

In some embodiments, when the result of attempting to decode the communication over the PDSCH is the failure to decode or the failure to detect that communication, the communication over the PDSCH may be retransmitted. For example, in some embodiments, the UE 120 receives a second communication over the PDSCH which may be encoded with the same modulation and coding scheme (MSC) as the previously received, but not decoded, communication over the PDSCH. Alternatively, in some embodiments, the UE 120 receives a second communication over the PDSCH which is transmitted using a more robust MSC than the previously received, but not decoded, communication over the PDSCH. Information about the second communication over the PDSCH may be included in the same DCI as the information about the prior communication over the PDSCH. In some embodiments, about the second communication over the PDSCH may be included in a different DCI that is received by the UE 120. The UE 120 attempts to detect and, if the decoding is successful, to decode the second communication over the PDSCH in accordance with embodiments of the present disclosure. If the decoding of the second communication over the PDSCH is successful, the UE 120 transmits a corresponding communication over the PUSCH.

In some embodiments, if the attempt to decode the DCI is a failure to decode the DCI, the UE may not attempt to decode the communication over the PDSCH and no communication over the PUSCH is transmitted.

It should be appreciated that, although the above example describes embodiments in which a second communication or an acknowledgment over the PUSCH is sent by the UE 120 after the UE 120 has received a first communication over the PDSCH, in some embodiments a second communication over the PUSCH is sent before a corresponding first communication over the PDSCH. In some embodiments, first and second communications over the PDSCH and PUSCH, respectively, may be sent in any suitable order.

### DCI

Downlink Control Information (DCI) carrier control information used to schedule transmission of data. Information in the DCI provides a UE with information such as, e.g. location of data scheduled for transmission, modulating and coding scheme used for data transmissions, physical layer resource allocation, power control commands, and HARQ information for both uplink and downlink.

DCI may be transmitted on the Physical Downlink Control Channel (PDCCH) or on a PDSCH channel. In 5G, the DCI may be transmitted with 24-bit cyclic redundancy check (CRC) attachment, whereas 16-bit CRC was defined for LTE. A UE needs to decode DCI before it can decode downlink data or encode uplink data. Various DCI may be defined depending on a use context, and Table 1 below provides DCI formats and their usage.

TABLE 1
DCI formats.

| DCI Format | Usage |
|---|---|
| Format 0_0 | Scheduling PUSCH in one cell |
| Format 0_1 | Scheduling PUSCH in one cell |
| Format 1_0 | Scheduling PDSCH in one cell |
| Format 1_1 | Scheduling PDSCH in one cell |
| Format 2_0 | Notify a group of UEs of the slot format |
| Format 2_1 | Notify a group of UE resources where they |
| | may assume no transmission for the UE |
| Format 2_2 | Transmit Power Control (TPC) commands |
| | for PUCCH and PUSCH |
| Format 2_3 | Transmission of a group of TPC commands |
| | for SRS transmissions by one or more UEs |

Format 0 is for uplink grant, meaning that it includes information that pertains to data the UE may transmit in an uplink communication.

Format 1 is for downlink allocation, meaning that it includes information about the way data was sent to the UE.

For both uplink and downlink information, format_0, with underscore zero, is referred to as a fallback format, and it is more compact than the full format with underscore one (format_1) because format_0 is more compact and therefore it trades off less scheduling flexibility for reduced control overhead.

The format 2 addresses information needed for groups of UEs and Transmit Power Control (TPC) commands.

In some embodiments, the DCI may allocate both PDSCH and PUSCH communications, e.g., a DCI format may be a combination of:
(a) Format 0_X and Format 1_Y, where X=0,1 and Y=0,1; or
(b) Format 0_X, Format 1_Y, and Format 2_Z, where X=0,1, Y=0,1, and Z=0,1.

### DCI Resource Allocation

In embodiments herein, the DCI comprises information on decoding parameters for first communications over the PDSCH, encoding parameters for uplink data to be transmitted via second communications over the PUSCH, and encoding parameters for one or more types of ACK or NACK communications over the PUSCH. In embodiments herein, the information in the DCI specifies first communications over the PDSCH for transmission from the network node 110 to the UE 120, and second communications over the PUSCH for transmission from the UE 120 to the network node 110. Embodiments below describe various examples of information that may be included in the DCI in accordance with embodiments of the present disclosure.

### Multiple Communications

In some embodiments, the DCI includes information for generating the first number of first communications over the PDSCH and the second number of second communications over the PUSCH. For example, in an embodiment, a DCI can allocate N first communications over the PDSCH and M second communications over the PUSCH, wherein each of N and M is equal to or greater than 1. The sum of the first and second numbers is greater than two. For example, if the DCI allocates one (e.g. N=1) communication from the first communications, the DCI allocates more than one (e.g. M=1+x, where x is a positive integer greater than 1, x>1) communications from the second communications. Similarly, if the DCI allocates one (e.g. M=1) communication from the second communications, the DCI allocates more than one (e.g. N=1+x, where x is a positive integer greater than 1, x>1) communications from the first communications.

In some embodiments, the first number of first communications is greater than one, and the second number of the second communications is greater than one. In some embodiments, each communications over the PDSCH and each second communications over the PUSCH represents one TB or HARQ process in the respective direction. Thus, for example, there may be N downlink HARQ processes and M uplink HARQ processes.

### Repetitions

In some embodiments, repetition information is included in the DCI that schedules the repetitions. For example, the DCI may include information, e.g., that a first communication over the PDSCH is to be transmitted with R1 repetitions, and a second communication over the PUSCH is to be transmitted with R2 repetitions.

In some embodiments, one or more of the first number of first communications over the PDSCH, or PDSCHs, may comprise two or more repetitions. Similarly, additionally or alternatively, in some embodiments, one or more of the second number of the second communications over the PUSCH, or PUSCHs, may comprise two or more repetitions. For example, in an embodiment, a DCI may allocate N=2 PDSCHs (e.g. PDSCH #1, PDSCH #2) and M=3 PUSCHs (e.g. PUSCH #1, PUSCH #2 and PUSCH #3), wherein PDSCH #1 is allocated with R1 repetitions, PDSCH #2 is allocated with R2 repetitions, PUSCH #1 is allocated with R3 repetitions, PUSCH #2 is allocated with R4 repetitions, and PUSCH #3 is allocated with R5 repetitions.

The information on repetitions may be associated with Radio Resource Control (RRC) information, e.g. the DCI may point to some information in the RRC from which the UE may derive the repetition related information. Information on repetitions may be included, e.g. in a Time Domain Resource Assignment (TDRA) table or field in the DCI, or in a Frequency Domain Resource Assignment (FDRA) table or field in the DCI.

In some embodiments, a first communication from the first number of the first communications comprises at least two repetitions, and a second communication from the second number of the second communications comprises at least two repetitions. In some embodiments, the first communication from the first number of the first communications comprises at least two repetitions, not the second number of the second communications do not include repetitions. In some embodiments, first number of the first communications do not include repetitions, but the second communication from the second number of the second communications comprises at least two repetitions.

In some embodiments, a communication from any one out of the first number of the first communications and the second number of the second communications comprises a first number of repetitions and another communication from any one out of the first number of the first communications and the second number of the second communications comprises a second number of repetitions.

In some embodiments, a first communication of the first number of the first communications over the PDSCH comprises a certain number of repetitions, and a second communication of the second number of the second communications over the PUSCH comprises a different number of repetitions. As another variation, among the first communications over the PDSCH, two or more communications may have different number of repetitions. In some embodiments, among the second communications over the PUSCH, two or more communications may have different number of repetitions.

### Time Gap

In some embodiments, the information in the DCI specifies that a time gap is included between any of the first communications over the PDSCH and the second communications over the PUSCH, or between their repetitions. In some embodiments, a time gap is included between any one out of the first communication from the first number of the first communications, the second communication from the second number of the second communications, the first number of repetitions, and the second number of repetitions.

In some embodiments, the DCI specifies that a time gap is included between any one or more out of:
different communications from the first number of the first communications,
different communications from the second number of the second communications,
at least one communication from the first number of the first communications and at least one communication from the second number of the second communications,
different repetitions from the first number of repetitions, and
different repetitions from the second number of repetitions.

### Overlap in Various Domains

In some embodiments, the information in the DCI specifies that any one out of the first number of the first communications, the first number of repetitions of the first number of the first communications, the second number of the second communications, and the second number of repetitions of the second number of the second communications overlap in any one or more out of:
a time domain but not in a frequency domain, e.g., two or more PDSCHs overlap in time domain, or two or more PUSCHs overlap in time domain;
the frequency domain but not in the time domain, and
the time domain and the frequency domain but not in a spatial domain.

In some embodiments, the first communications over the PDSCH and the second communications over the PUSCH, and their respective repetitions, partly overlap in the time domain and partly overlap in the frequency domain. For example, a subset of the PDSCHs or PUSCHs communications may overlap in the time domain, and another, not overlapping subset of the PDSCHs or PUSCHs communications may overlap in the frequency domain. In some embodiments, each of the subsets do not overlap in either the time domain or the frequency domain.

In some embodiments, the first communications over the PDSCH and the second communications over the PUSCH, and their respective repetitions, do not overlap in the time and frequency domains.

### Service Use

In some embodiments, the first number of the first communications and the second number of the second communications belong to the same service. In some embodiments, the first number of the first communications and the second number of the second communications belong to different services. A service may be associated with a certain Quality of Service (QOS) or reliability. Non-limiting examples of the service include URLLC, eMBB, XR, or any combinations thereof. Services can be differentiated based on reliability and latency budget of packet transmissions. For example, a first TB and a second TB may belong to different services, e.g., one TB is a part of eMBB and another TB is URLLC.

In some embodiments, the DCI defines allocation for any of:

The first number of the first communications over the PDSCH or repetitions thereof, and
the second number of the second communications over the PUSCH or repetitions thereof, such that the allocations for PDSCHs and PUSCHs belong to same service, or Quality of Service (QOS), or reliability.

In some embodiments, the DCI defines allocation for any of: the first number of the first communications over the PDSCH or repetitions thereof, and the second number of the second communications over the PUSCH or repetitions thereof, such that the allocations for PDSCHs and PUSCHs belong to a different service, or QoS, or reliability. A same service may be defined as dependency between transmissions, or transmissions having the same physical layer (PHY) or medium access control (MAC) or logical channel priority, or transmissions having the same reliability target. In other cases, services may be considered different. In some cases, different services may have different data bearer configurations.

In some embodiments, the information in the DCI specifies different parameters for allocating the first number of the first communications over the PDSCH and the second number of the second communications over the PUSCH.

### Parameter Use

In some embodiments, the information in the DCI specifies that a communication from any one out of the first number of the first communications and the second number of the second communications is allocated using one or more common parameters. For example, in some embodiments, both downlink and uplink communications are allocated such that they have the same Hybrid Automatic Repeat Request (HARQ) identifier (ID). For 5G NR, the 3GPP specification has defined HARQ Codebook to provide a feedback to base station for downlink data transmission over the PDSCH. Thus, in some embodiments, the UE 120 may send an ACK/NACK for a first communication over the PDSCH in a corresponding communication over the PUSCH. Multiple HARQ processes are supported per UE and a separate feedback may be required for each HARQ process.

In some embodiments, when the DCI specifies that downlink and uplink communications have the same HARQ ID. For example, if the DCI allocates one communication over the PDSCH and one communication over the PUSCH, and the DCI includes a HARQ ID comprising ID X, the communication over the PDSCH will have a HARQ process ID X and the communication over the PUSCH will also have the same HARQ ID X.

In some embodiments, the information in the DCI specifies that both downlink and uplink communications have the same Modulation and Coding Scheme (MCS). For example, if the DCI allocates N first communications over the PDSCH and M second communications over the PUSCH, then all these first and second communications are scheduled with same MCS.

In some embodiments, the information in the DCI specifies that both downlink and uplink communications have the same Physical Layer (PHY) priority.

In some embodiments, the information in the DCI specifies different parameters for allocating the first number of the first communications over the PDSCH and the second number of the second communications over the PUSCH. For example, if the DCI allocates N first communications over the PDSCH and M second communications over the PUSCH, then the DCI indicates N MCS values each for N first communications over the PDSCH and M MCS values each for M second communications over the PUSCH

Furthermore, in embodiments in which the DCI allocates N first communications over the PDSCH and M second communications over the PUSCH, the DCI may further allocate N HARQ IDs for N first communications over the PDSCH and M HARQ IDs for M second communications over the PUSCH.

### Order of PDSCHs and PUSCHs

In some embodiments, according to information in a single DCI in accordance with embodiments of the present disclosure, first communications over the PDSCH are allocated before second communications over the PUSCH. In some embodiments, according to information in the single DCI, second communications over the PUSCH are allocated before first communications over the PDSCH.

Furthermore, in some embodiments, a first number of the first communications over the PDSCH and a second number of the second communications over the PUSCH may be allocated in various orders, such that a certain number of first communications may follow a certain number of second communications, and vice versa. For example, if a DCI allocates three PDSCH communications, e.g. PDSCH #1, PDSCH #2, and PDSCH #3, and two PUSCH communications, e.g. PUSCH #1 and PUSCH #2, the allocation may be in the following order: PUSCH #1, PDSCH #1, PDSCH #2, PUSCH #2, and PDSCH #3, i.e., the first PUSCH #1 is followed by the two PDSCH communications, PDSCH #1 and PDSCH #2, which are in turn followed by the second and third PUSCHs, PUSCH #2 and PDSCH #3.

In some embodiments, when one or more second communications over the PUSCH are allocated before one or more first communication over the PDSCH, an HARQ-ACK in response to the communications over the PUSCH are not sent in second communications over the allocated PUSCH, because the communications over the PDSCH occur after the PUSCH communications. Accordingly, HARQ-ACK in response to the communications over the PUSCH may be sent over a PDCCH communication which is allocated after the PDSCH communications. In some embodiments herein, if there is need for a feedback regarding a second communication over the PUSCH, a downlink feedback indicator (DFI) or another type of a feedback regarding the second communication over the PUSCH is transmitted in the downlink, in a first communication over the PDSCH. Information about the DFI may be included in the same DCI. In some embodiments, information about the DFI may be included in a different DCI, which may be multiplexed with the communication over the PDSCH.

### HARQ Processes

In some embodiments, the first number of the first communications comprises N HARQ processes and the second number of the second communications comprises M HARQ processes, and one HARQ ID is used for the N+M HARQ processes. HARQ identifier (ID) is identity used to identify an uplink or downlink transmission. Depending on scheduling or allocation, a HARQ ID may be sent in a scheduling DCI, or a HARQ ID may be derived from transmission allocation, e.g. for Configured Grant (CG) or Semi Persistent Scheduling (SPS) transmissions. An HARQ ID may be derived from an uplink control information (UCI), e.g. in uplink CG transmissions.

In some embodiments, when the DCI schedules the total of N+M HARQ processes and indicates one HARQ ID, defined as X in this example, the following rules may be used for the assignment of the HARQ processes:
Each first communication over the PDSCH is incremented by 1, so that for N consecutive communication over the PDSCH, their respective HARQ IDs are from X to X+N. For M second communications over the PUSCH, there may be the following options:
   the respective IDs for the M communications over the PUSCH may be from X+N+1 to X+N+M, or
   the respective IDs for the M communications over the PUSCH may be from X+1 to X+M.

It should be noted that a number of values which may be assigned to HARQ IDs may be limited. Accordingly, in some embodiments, once a maximum value is reached as HARQ IDs are assigned to communications, a next ID may start with 0 and then it may be continually incremented. For example, if a maximum value for an HARQ ID is 15 e.g. if X+a is 15 (where a is increment), then X+a+1 is 0, X+a+2 is 1, and so on.

In some embodiments, the DCI specifies that a HARQ Acknowledgment (HARQ-ACK), also referred to as a HARQ-ACK feedback, of a communication from the first number of the first communications over the PDSCH is to be sent in a corresponding communication from the second number of the second communications over the PUSCH. In some embodiments, the HARQ-ACK of the PDSCH communication may be sent in a Physical Uplink Control Channel (PUCCH). In some embodiments, the HARQ-ACK of the PDSCH communication may be included in an Uplink Control Information (UCI) or a Configured Grant UCI (CG-UCI), which is carried by the PUCCH from the UE 120 to the network node 110. For configured grants operation with shared spectrum channel access, CG-UCI may be transmitted in PUSCH scheduled by configured uplink grant.

In some embodiments, the UCI or CG-UCI may be multiplexed with PUSCH. For example, in some embodiments, a UCI carrying a HARQ-ACK feedback with 1 or 2 bits is multiplexed by puncturing a PUSCH. In some embodiments, a UCI carrying a HARQ-ACK feedback is multiplexed by rate matching a PUSCH.

In some embodiments, the DCI specifies that a HARQ-ACK of a communication from the second number of the second communications over the PUSCH is to be sent in a corresponding communication from the first number of the first communications over the PDSCH. In other words, a feedback for a PUSCH communication is provided in a corresponding PDSCH communication, wherein both the PUSCH and PDSCH communications are allocated by the same DCI and the PUSCH allocation is scheduled before the PDSCH allocation. In some embodiments, a feedback for a PUSCH communication in the form of a HARQ-ACK may be sent via Physical Uplink Control Channel (PUCCH). In some embodiments, a HARQ-ACK may be sent via the PUCCH in a DFI which may be multiplexed with a PDSCH communication.

In some embodiments, the DCI allocates a resource with a flexible number of one or more of symbols, slots, or mini-slots. The flexible number means that a different number of symbols, mini-slots, or slots may be utilized for resource allocation. For example, in 5G NR, a transmission size may be such that it fits within a slot boundary. In some embodiments, a transmission may occur on multiple slots without segmenting the transmission data.

In some embodiments, the information in the DCI specifies information related to encoding parameters for PUSCH communications and information related to decoding for PDSCH communication, but the DCI may not specify one or more resources for the PDSCH and PUSCH communications. In some embodiments, the DCI specifies one or more resources for the PDSCH and PUSCH communications.

In some embodiments, the symbols, slots, and/or mini-slots included in the DCI information may specify the following:
The network node 110 such as, e.g. a gNB sends one or more PDSCH communications, depending on arrived traffic on symbols/slots, and
   after the UE receives the PDSCH communications, the rest or remaining resource may be used for one or more PUSCH communications by the UE, and/or
   In the PDSCHs communications, the UE may indicate what symbols/slots can be used for PUSCH and PDSCH communications;
The UE 120 first sends PUSCH communications, depending on arrived traffic in buffer on symbols/slots, and
   after the network node receives the PUSCH communications, the rest or remaining resource can be used for PDSCH communications by the network node, and/or
   The UE can include UCI or CG-UCI in the PUSCH communications, wherein the UCI or CG-UCI may indicate what symbols/slots can be used for PUSCH communications and the remaining resource which is not used for the PUSCH communications by the UE.

### Configuration of the UE 120

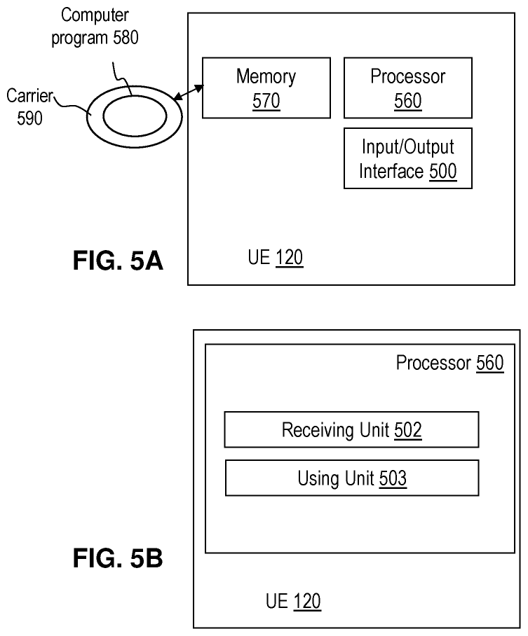

To perform the method actions above, the UE 120 is configured for communicating with the network node 110 in the wireless communications network 100. In some embodiments, the UE 120 may comprise an arrangement depicted in FIGS. 5A and 5B.

As shown in FIG. 5A, the UE 120 may comprise an input and output interface 500 configured to communicate with network nodes such as the network node 110. The input and output interface 500 may comprise a wireless receiver (not shown) and a wireless transmitter (not shown).

The UE 120 may be configured to, e.g. by means of a receiving unit 501 in the UE 120, receive the DCI from the network node 110. The DCI comprises information for generating the first number of first communications over the PDSCH and the second number of second communications over the PUSCH. In some embodiments, the sum of the first and second numbers is greater than two.

In some embodiments, any one or more out of:
A first communication from the first number of the first communications comprises at least two repetitions,
a second communication from the second number of the second communications comprises at least two repetitions, and
a communication from any one out of the first number of the first communications and the second number of the second communications comprises a first number of repetitions and another communication from any one out of the first number of the first communications and the second number of the second communications comprises a second number of repetitions.

In some embodiments, any one or more out of:
Different communications from the first number of the first communications,
different communications from the second number of the second communications,
at least one communication from the first number of the first communications and at least one communication from the second number of the second communications,
different repetitions from the first number of repetitions, and
different repetitions from the second number of repetitions.

In some embodiments, the information in the DCI specifies that any one out of the first number of the first communications, the first number of repetitions of the first number of the first communications, the second number of the second communications, and the second number of repetitions of the second number of the second communications overlap in any one or more out of:
A time domain but not in a frequency domain,
the frequency domain but not in the time domain,
partly in the time domain and partly in the frequency domain, and
the time domain and the frequency domain but not in a spatial domain.

In some embodiments, the information in the DCI specifies different parameters for allocating the first number of the first communications over the PDSCH and the second number of the second communications over the PUSCH.

In some embodiments, the information in the DCI specifies that a communication from any one out of the first number of the first communications and the second number of the second communications is allocated using any one or more out of:
A same Hybrid Automatic Repeat Request, HARQ, identifier, ID,
a same Modulation and Coding Scheme, MCS, and
a same Physical Layer, PHY, priority.

In some embodiments, the information in the DCI specifies any one or more out of:
the first number of the first communications and the second number of the second communications belong to the same service,
the first number of the first communications and the second number of the second communications belong to different services,
the first number of the first communications comprises N Hybrid Automatic Repeat Request, HARQ, processes and the second number of the second communications comprises M HARQ processes, and one HARQ identifier, ID, is used for the N+M HARQ processes,
a HARQ Acknowledgment, HARQ-ACK, of a communication from the first number of the first communications is to be sent in a corresponding communication from the second number of the second communications, and
a HARQ-ACK of a communication from the second number of the second communications is to be sent in a corresponding communication from the first number of the first communications.

In some embodiments, the UE 120 may further be configured to, e.g. by means of a using unit 502 in the UE 120, use the information in the DCI to communicate with the network node 110 in the wireless communications network 100. The information in the DCI may be used in various ways, to schedule uplink and downlink communications in accordance with that information

The embodiments herein may be implemented through a respective processor or one or more processors, such as the processor 560 of a processing circuitry in the UE 120 depicted in FIG. 5B, together with respective computer program code for performing the functions and actions of the embodiments herein. The program code mentioned above may also be provided as a computer program product, for instance in the form of a data carrier carrying computer program code for performing the embodiments herein when being loaded into the UE 120. One such carrier may be in the form of a CD ROM disc. It is however feasible with other data carriers such as a memory stick. The computer program code may furthermore be provided as pure program code on a server and downloaded to the UE 120.

The UE 120 may further comprise a memory 570 comprising one or more memory units. The memory 570 comprises instructions executable by the processor in the UE 120. The memory 570 is arranged to be used to store e.g. information, indications, data, configurations, and applications to perform the methods herein when being executed in the UE 120.

In some embodiments, a computer program 580 comprises instructions, which when executed by the respective at least one processor 560, cause the at least one processor of the UE 120 to perform the actions above.

In some embodiments, a respective carrier 590 comprises the respective computer program 580, wherein the carrier 590 is one of an electronic signal, an optical signal, an electromagnetic signal, a magnetic signal, an electric signal, a radio signal, a microwave signal, or a computer-readable storage medium.

Those skilled in the art will appreciate that the units in the UE 120 described above may refer to a combination of analog and digital circuits, and/or one or more processors configured with software and/or firmware, e.g. stored in the UE 120. The software and/or firmware, when executed by the respective one or more processors such as the processors described above, cause the one or more processors to carry out the actions described herein, as performed by the UE 120. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

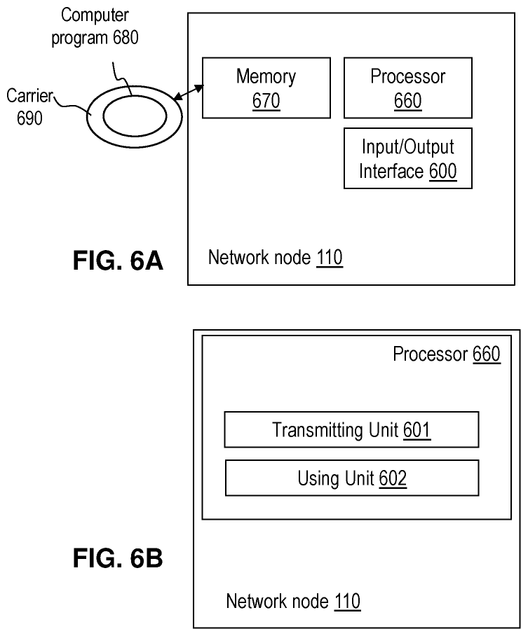

To perform the method actions above, the network node 110 is configured to communicate with the UE 120 in the wireless communications network 100. The network node 110 may comprise an arrangement depicted in FIGS. 6A and 6B.

As shown in FIG. 6A, the network node 110 may comprise an input and output interface 600 configured to communicate with UEs such as the UE 120. The input and output interface 600 may comprise a wireless receiver (not shown) and a wireless transmitter (not shown).

The network node 110 may be configured to, e.g. by means of a transmitting unit 601 in the network node 110, transmit the DCI to the UE 120. The DCI comprises information for generating the first number of first communications over the PDSCH and the second number of second communications over the PUSCH. In some embodiments, the sum of the first and second numbers is greater than two.

In some embodiments, any one or more out of:
A first communication from the first number of the first communications comprises at least two repetitions,
a second communication from the second number of the second communications comprises at least two repetitions, and
a communication from any one out of the first number of the first communications and the second number of the second communications comprises a first number of repetitions and another communication from any one out of the first number of the first communications and the second number of the second communications comprises a second number of repetitions.

In some embodiments, the information in the DCI specifies that a time gap is included between any one or more out of:
Different communications from the first number of the first communications,
different communications from the second number of the second communications,
at least one communication from the first number of the first communications and at least one communication from the second number of the second communications,
different repetitions from the first number of repetitions, and
different repetitions from the second number of repetitions.

In some embodiments, the information in the DCI specifies that any one out of the first number of the first communications, the first number of repetitions of the first number of the first communications, the second number of the second communications, and the second number of repetitions of the second number of the second communications overlap in any one or more out of:
A time domain but not in a frequency domain,
the frequency domain but not in the time domain,
partly in the time domain and partly in the frequency domain, and
the time domain and the frequency domain but not in a spatial domain.

In some embodiments, the information in the DCI specifies different parameters for allocating the first number of the first communications over the PDSCH and the second number of the second communications over the PUSCH.

In some embodiments, the information in the DCI specifies that a communication from any one out of the first number of the first communications and the second number of the second communications is allocated using any one or more out of:
A same Hybrid Automatic Repeat Request, HARQ, identifier, ID,
a same Modulation and Coding Scheme, MCS, and
a same Physical Layer, PHY, priority.

In some embodiments, the information in the DCI specifies any one or more out of:
The first number of the first communications and the second number of the second communications belong to the same service,
the first number of the first communications and the second number of the second communications belong to different services,
the first number of the first communications comprises N Hybrid Automatic Repeat Request, HARQ, processes and the second number of the second communications comprises M HARQ processes, and one HARQ identifier, ID, is used for the N+M HARQ processes,
a HARQ Acknowledgment, HARQ-ACK, of a communication from the first number of the first communications is to be sent in a corresponding communication from the second number of the second communications, and
a HARQ-ACK of a communication from the second number of the second communications is to be sent in a corresponding communication from the first number of the first communications.

In some embodiments, the network node 110 may further be configured to, e.g. by means of a using unit 602 in the network node 110, use the information in the DCI to communicate with the UE 120 in the wireless communications network 100. The information in the DCI may be used in various ways.

The embodiments herein may be implemented through a respective processor or one or more processors, such as the processor 660 of a processing circuitry in the network node 110 depicted in FIG. 6B, together with respective computer program code for performing the functions and actions of the embodiments herein. The program code mentioned above may also be provided as a computer program product, for instance in the form of a data carrier carrying computer program code for performing the embodiments herein when being loaded into the network node 110. One such carrier may be in the form of a CD ROM disc. It is however feasible with other data carriers such as a memory stick. The computer program code may furthermore be provided as pure program code on a server and downloaded to the network node 110.

The network node 110 may further comprise a memory 670 comprising one or more memory units. The memory 670 comprises instructions executable by the processor in the network node 110. The memory 670 is arranged to be used to store e.g. information, indications, data, configurations, and applications to perform the methods herein when being executed in the network node 110.

In some embodiments, a computer program 680 comprises instructions, which when executed by the respective at least one processor 660, cause the at least one processor of the network node 110 to perform the actions above.

In some embodiments, a respective carrier 690 comprises the respective computer program 680, wherein the carrier 690 is one of an electronic signal, an optical signal, an electromagnetic signal, a magnetic signal, an electric signal, a radio signal, a microwave signal, or a computer-readable storage medium.

Those skilled in the art will appreciate that the units in the network node 110 described above may refer to a combination of analog and digital circuits, and/or one or more processors configured with software and/or firmware, e.g. stored in the network node 110. The software and/or firmware, when executed by the respective one or more processors such as the processors described above, cause the one or more processors to carry out the actions described herein, as performed by the network node 110. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

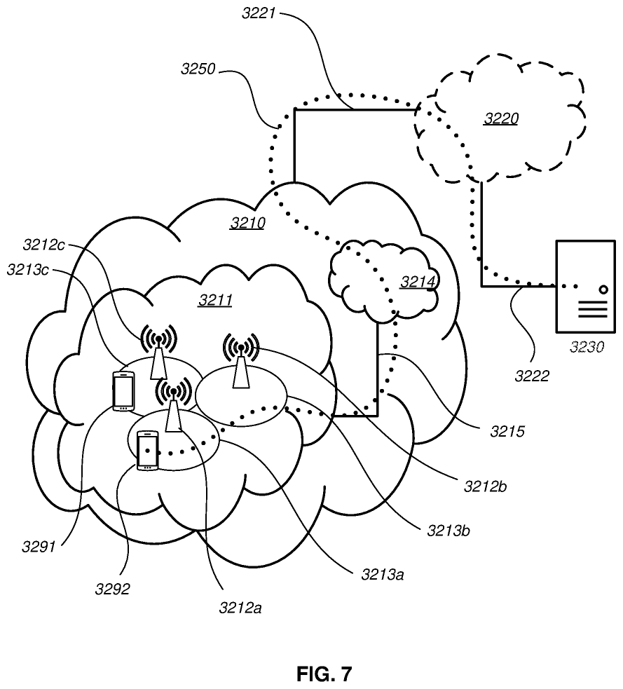

With reference to FIG. 7, in accordance with an embodiment, a communication system includes a telecommunication network 3210, such as a 3GPP-type cellular network, e.g. the wireless communications network 100, which comprises an access network 3211, such as a radio access network, and a core network 3214. The access network 3211 comprises a plurality of base stations 3212a, 3212b, 3212c, e.g. the network node 110, such as AP STAs NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A user equipment (UE) such as a Non-AP STA 3291, e.g. the UE 120 in some embodiments, located in coverage area 3213c is configured to wirelessly connect to, or be paged by, the corresponding base station 3212c. A second UE 3292, such as a Non-AP STA, e.g. the UE 120 in some embodiments, in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 7 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

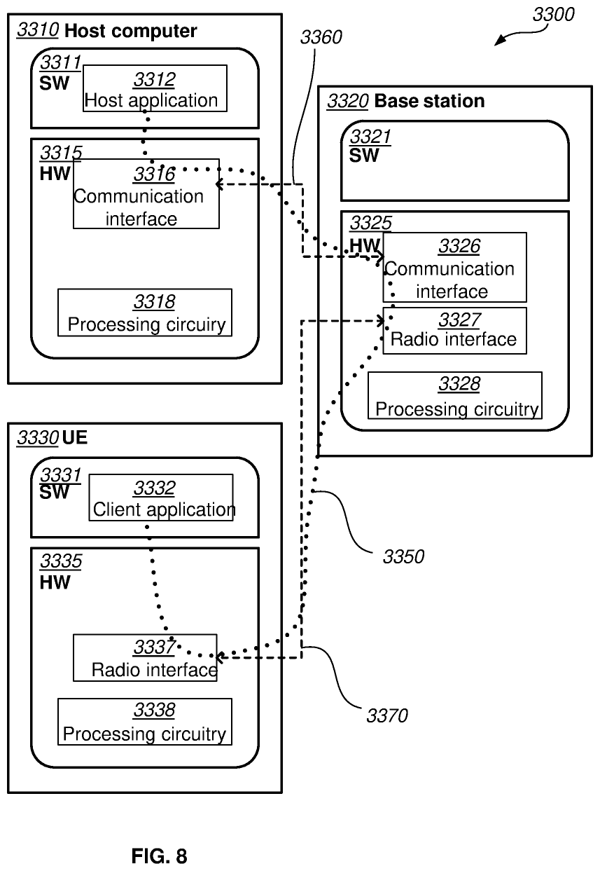

Example implementations, in accordance with an embodiment, of the UE, base station and host computer discussed in the preceding paragraphs will now be described with reference to FIG. 8. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 8) served by the base station 3320. The communication interface 3326 may be configured to facilitate a connection 3360 to the host computer 3310. The connection 3360 may be direct or it may pass through a core network (not shown in FIG. 8) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides. It is noted that the host computer 3310, base station 3320 and UE 3330 illustrated in FIG. 8 may be identical to the host computer 3230, one of the base stations 3212a, 3212b, 3212c and one of the UEs 3291, 3292 of FIG. 7, respectively. This is to say, the inner workings of these entities may be as shown in FIG. 8 and independently, the surrounding network topology may be that of FIG. 7.

In FIG. 8, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the RAN effect: data rate, latency, power consumption and thereby provide benefits such as corresponding effect on the OTT service: reduced user waiting time, relaxed restriction on file size, better responsiveness, extended battery lifetime.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

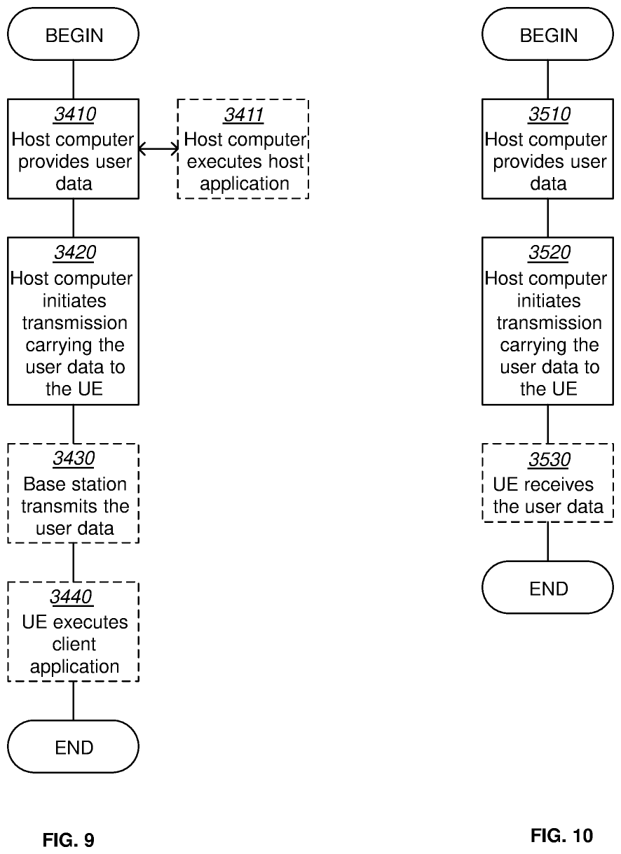

FIG. 9 is a flowchart illustrating a method implemented in a communication system, in accordance with one embodiment. The communication system includes a host computer, a base station such as a AP STA, and a UE such as a Non-AP STA which may be those described with reference to FIG. 8 and FIG. 7. For simplicity of the present disclosure, only drawing references to FIG. 9 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

FIG. 10 is a flowchart illustrating a method implemented in a communication system, in accordance with one embodiment. The communication system includes a host computer, a base station such as a AP STA, and a UE such as a Non-AP STA which may be those described with reference to FIG. 7 and FIG. 8. For simplicity of the present disclosure, only drawing references to FIG. 10 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

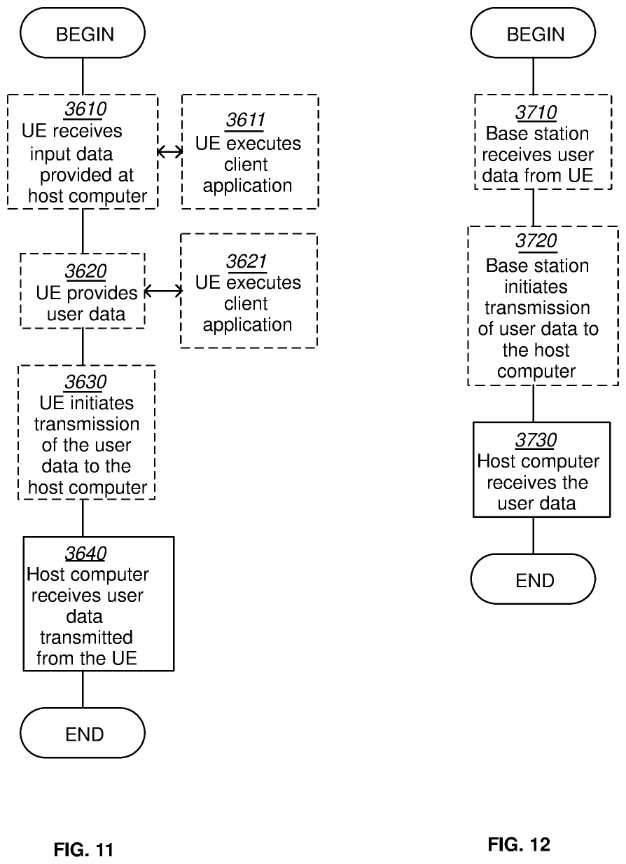

FIG. 11 is a flowchart illustrating a method implemented in a communication system, in accordance with one embodiment. The communication system includes a host computer, a base station such as a AP STA, and a UE such as a Non-AP STA which may be those described with reference to FIG. 7 and FIG. 8. For simplicity of the present disclosure, only drawing references to FIG. 11 will be included in this section. In an optional first step 3610 of the method, the UE receives input data provided by the host computer. Additionally or alternatively, in an optional second step 3620, the UE provides user data. In an optional substep 3621 of the second step 3620, the UE provides the user data by executing a client application. In a further optional substep 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third substep 3630, transmission of the user data to the host computer. In a fourth step 3640 of the method, the host computer receives the user data transmitted from the UE, in accordance with the teachings of the embodiments described throughout this disclosure.

FIG. 12 is a flowchart illustrating a method implemented in a communication system, in accordance with one embodiment. The communication system includes a host computer, a base station such as a AP STA, and a UE such as a Non-AP STA which may be those described with reference to FIG. 7 and FIG. 8. For simplicity of the present disclosure, only drawing references to FIG. 12 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

When using the word “comprise” or “comprising” it shall be interpreted as non-limiting, i.e. meaning “consist at least of”.

The embodiments herein are not limited to the above-described preferred embodiments. Various alternatives, modifications and equivalents may be used.

1. A method performed by a User Equipment (UE) for communicating with a network node in a wireless communications network, the method comprising:
receiving a downlink control information (DCI) from the network node, the DCI comprising information for generating a first number of first communications over a physical downlink shared channel (PDSCH) and a second number of second communications over a physical uplink shared channel (PUSCH) wherein a sum of the first and second numbers is greater than two; and
using the information in the DCI to communicate with the network node in the wireless communications network.

2. The method according to claim 1, wherein any one or more out of:
a first communication from the first number of the first communications comprises at least two repetitions;
a second communication from the second number of the second communications comprises at least two repetitions; and
a communication from any one out of the first number of the first communications and the second number of the second communications comprises a first number of repetitions and another communication from any one out of the first number of the first communications and the second number of the second communications comprises a second number of repetitions.

3. The method according to claim 2, wherein the information in the DCI specifies that a time gap is included between any one or more out of:
different communications from the first number of the first communications;
different communications from the second number of the second communications;
at least one communication from the first number of the first communications and at least one communication from the second number of the second communications;
different repetitions from the first number of repetitions; and
different repetitions from the second number of repetitions.

4. The method according to claim 2, wherein the information in the DCI specifies that any one out of the first number of the first communications, the first number of repetitions of the first number of the first communications, the second number of the second communications, and the second number of repetitions of the second number of the second communications overlap in any one or more out of:
a time domain but not in a frequency domain;
the frequency domain but not in the time domain;
partly in the time domain and partly in the frequency domain; and
the time domain and the frequency domain but not in a spatial domain.

5. The method according to claim 1, wherein the information in the DCI specifies different parameters for allocating the first number of the first communications over the PDSCH and the second number of the second communications over the PUSCH.

6. The method according to claim 1, wherein the information in the DCI specifies that a communication from any one out of the first number of the first communications and the second number of the second communications is allocated using any one or more out of:
a same Hybrid Automatic Repeat Request (HARQ) identifier (ID);
a same Modulation and Coding Scheme (MCS); and
a same Physical Layer (PHY) priority.

7. The method according to claim 1, wherein the information in the DCI specifies any one or more out of:
the first number of the first communications and the second number of the second communications belong to the same service;
the first number of the first communications and the second number of the second communications belong to different services;
the first number of the first communications comprises N Hybrid Automatic Repeat Request (HARQ) processes and the second number of the second communications comprises M HARQ processes, and one HARQ identifier (ID) is used for the N+M HARQ processes;
a HARQ Acknowledgment (HARQ-ACK) of a communication from the first number of the first communications is to be sent in a corresponding communication from the second number of the second communications; and
a HARQ-ACK of a communication from the second number of the second communications is to be sent in a corresponding communication from the first number of the first communications.

8. (canceled)

9. (canceled)

10. A method performed by a network node for communicating with a User Equipment (UE) in a wireless communications network, the method comprising:
transmitting a downlink control information (DCI) to the UE, the DCI comprising information for generating a first number of first communications over a physical downlink shared channel (PDSCH) and a second number of second communications over a physical uplink shared channel (PUSCH), wherein a sum of the first and second numbers is greater than two; and
using the information in the DCI to communicate with the UE in the wireless communications network.

11. The method according to claim 10, wherein any one or more out of:
a first communication from the first number of the first communications comprises at least two repetitions;
a second communication from the second number of the second communications comprises at least two repetition; and
a communication from any one out of the first number of the first communications and the second number of the second communications comprises a first number of repetitions and another communication from any one out of the first number of the first communications and the second number of the second communications comprises a second number of repetitions.

12. The method according to claim 11, wherein the information in the DCI specifies that a time gap is included between any one or more out of:
different communications from the first number of the first communications;
different communications from the second number of the second communications;
at least one communication from the first number of the first communications and at least one communication from the second number of the second communications;
different repetitions from the first number of repetitions; and
different repetitions from the second number of repetitions.

13. The method according to claim 11, wherein the information in the DCI specifies that any one out of the first number of the first communications, the first number of repetitions of the first number of the first communications, the second number of the second communications, and the second number of repetitions of the second number of the second communications overlap in any one or more out of:
a time domain but not in a frequency domain;
the frequency domain but not in the time domain;
partly in the time domain and partly in the frequency domain; and
the time domain and the frequency domain but not in a spatial domain.

14. The method according to claim 10, wherein the information in the DCI specifies different parameters for allocating the first number of the first communications over the PDSCH and the second number of the second communications over the PUSCH.

15. The method according to claim 10, wherein the information in the DCI specifies that a communication from any one out of the first number of the first communications and the second number of the second communications is allocated using any one or more out of:
a same Hybrid Automatic Repeat Request (HARQ) identifier (ID);
a same Modulation and Coding Scheme (MCS); and
a same Physical Layer (PHY) priority.

16. The method according to claim 10, wherein the information in the DCI specifies any one or more out of:
the first number of the first communications and the second number of the second communications belong to the same service;
the first number of the first communications and the second number of the second communications belong to different services;
the first number of the first communications comprises N Hybrid Automatic Repeat Request (HARQ) processes and the second number of the second communications comprises M HARQ processes, and one HARQ identifier (ID) is used for the N+M HARQ processes;
a HARQ Acknowledgment (HARQ-ACK) of a communication from the first number of the first communications is to be sent in a corresponding communication from the second number of the second communications; and
a HARQ-ACK of a communication from the second number of the second communications is to be sent in a corresponding communication from the first number of the first communications.

17. (canceled)

18. (canceled)

19. A User Equipment (UE) for communicating with a network mode in a wireless communications network, the UE being configured to:
receive a downlink control information (DCI) from the network node, the DCI comprising information for generating a first number of first communications over a physical downlink shared channel (PDSCH) and a second number of second communications over a physical uplink shared channel (PUSCH), wherein a sum of the first and second numbers is greater than two; and
use the information in the DCI to communicate with the network node in the wireless communications network.

20. The UE according to claim 19, wherein any one or more out of:
a first communication from the first number of the first communications comprises at least two repetitions;
a second communication from the second number of the second communications comprises at least two repetitions; and
a communication from any one out of the first number of the first communications and the second number of the second communications comprises a first number of repetitions and another communication from any one out of the first number of the first communications and the second number of the second communications comprises a second number of repetitions.

21. The UE according to claim 20, wherein the information in the DCI specifies that a time gap is included between any one or more out of:
different communications from the first number of the first communications;
different communications from the second number of the second communications;
at least one communication from the first number of the first communications and at least one communication from the second number of the second communications,
different repetitions from the first number of repetitions; and
different repetitions from the second number of repetitions.

22.-25. (canceled)

26. A network node for communicating with a User Equipment (UE) in a wireless communications network, wherein the network node is configured to:
transmit a downlink control information (DCI) to the UE, the DCI comprising information for generating a first number of first communications over a physical downlink shared channel (PDSCH) and a second number of second communications over a physical uplink shared channel (PUSCH), wherein a sum of the first and second numbers is greater than two; and
use the information in the DCI to communicate with the UE in the wireless communications network.

27. The network node according to claim 26, wherein any one or more out of:
a first communication from the first number of the first communications comprises at least two repetitions;
a second communication from the second number of the second communications comprises at least two repetitions; and
a communication from any one out of the first number of the first communications and the second number of the second communications comprises a first number of repetitions and another communication from any one out of the first number of the first communications and the second number of the second communications comprises a second number of repetitions.

28. The network node according to claim 27, wherein the information in the DCI specifies that a time gap is included between any one or more out of:
different communications from the first number of the first communications;
different communications from the second number of the second communications;
at least one communication from the first number of the first communications and at least one communication from the second number of the second communications;
different repetitions from the first number of repetitions; and
different repetitions from the second number of repetitions.

29.-32. (canceled)
